(19) United States
(12) Patent Application Publication
(10) Pub. No.: US 2021/0175844 A1
(43) Pub. Date: Jun. 10, 2021

(54) Waterless System for Cleaning Solar Panels

(71) Applicant: Suchin Jain, Delhi (IN)

(72) Inventor: Suchin Jain, Delhi (IN)

(21) Appl. No.: 16/769,575

(22) PCT Filed: Dec. 7, 2018
(86) PCT No.: PCT/IN2018/050818

§ 371 Date: Jun. 3, 2020

(30) Foreign Application Priority Data
Dec. 7, 2017 (IN) 201711044009

(51) Int. Cl. H02S 40/10; B08B 5/02

(52) U.S. Cl. CPC H02S 40/10; B08B 5/02

(57) ABSTRACT

A waterless system for cleaning solar panels is disclosed. The waterless system includes one or more solar panels with a nano coating. The system includes at least one compressor. The compressor pressurizes air at a predefined pressure. An air tank is coupled to the at least one compressor for storing pressurized air. The system includes at least one shut-off valve coupled to the air tank for regulating the flow of the pressurized air. The system includes a microprocessor for directing the opening and closing of the compressor and the shut-off valve. A frame is mounted on top of the one or solar panels for facilitating air flow and coupled to the shut-off valve. At least one work station includes a nozzle assembly for release of the pressurized air for cleaning purposes.

### FIELD OF INVENTION

The present invention relates to waterless system for cleaning solar cells. More specifically, the present invention relates to a pneumatic cleaning system employed for cleaning solar cells.

### BACKGROUND

Growing interest in renewable energy has led the solar photovoltaic industry to expand notably in the last decade. However, a big issue that is often overlooked is keeping panels clean. The output of a solar panel is mainly affected by different environmental factors like dust, color, irradiance, shading, etc. Also, accumulation of waste like bird poop on the panels results in reduced efficiency of the solar panel.

In order to overcome the said problem, various systems have been devised. Liquid based systems are one of the popular cleaning systems which provide water dependent cleaning of the panels. Considering water shortage all around the globe, utilization of water based systems is not a wise approach for cleaning panels. Also, autonomous cleaning robots have been introduced but such systems are only economical on a larger scale due to both installation costs and the fact that custom-made parts are needed to fit the plant. Moreover, these conventional cleaning systems are less efficient as dust particles tend to gradually accumulate on the PV surface making the cleaning task more difficult.

Therefore, a cleaning system which overcomes the hurdles of existing/conventional systems and offers an efficient, sustainable and cost effective solution to the aforesaid problem needs to be devised.

### SUMMARY

A waterless system for cleaning solar panels is disclosed. The waterless system includes one or more solar panels with a nano coating. The system includes at least one compressor. The compressor pressurizes air at a predefined pressure. An air tank is coupled to the at least one compressor for storing pressurized air. The system includes at least one shut-off valve coupled to the air tank for regulating the flow of the pressurized air. The system includes a microprocessor for directing the opening and closing of the compressor and the shut-off valve. A frame is mounted on top of the one or solar panels for facilitating air flow and coupled to the shut-off valve. At least one work station includes a nozzle assembly for release of the pressurized air for cleaning purposes.

### BRIEF DESCRIPTION OF DRAWINGS

The following summary/description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale.

FIG. 1 illustrates an exemplary architecture of a waterless system in accordance with an embodiment of the present invention.

FIG. 2 illustrates an exemplary working of the waterless system 100 in accordance with an embodiment of the present invention.

### DETAILED DESCRIPTION OF THE DRAWINGS

Prior to describing the invention in detail, definitions of certain words or phrases used throughout this patent document will be defined: the terms “include” and “comprise”, as well as derivatives thereof, mean inclusion without limitation; the term “or” is inclusive, meaning and/or; the phrases “coupled with” and “associated therewith”, as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; Definitions of certain words and phrases are provided throughout this patent document, and those of ordinary skill in the art will understand that such definitions apply in many, if not most, instances to prior as well as future uses of such defined words and phrases.

Wherever possible, same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Particular embodiments of the present disclosure are described herein below with reference to the accompanying drawings, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

The present invention discloses a waterless system for cleaning solar panels. The waterless system is a pneumatic cleaning system which employs pressurized air jet (pneumatic). Hence, use of water and associated water cost is eliminated. The present invention is an automated system and operated via a microprocessor. The microprocessor may be programmable logic controller. The waterless system causes reduction in the cost of manual operation. The waterless system cleans the solar panels in a way that all the dust, bird poop and all kinds of dirt are wiped out. From the aforesaid, the waterless system is a greener, more efficient and cost effective approach in cleaning the solar panels as compared to the conventional systems.

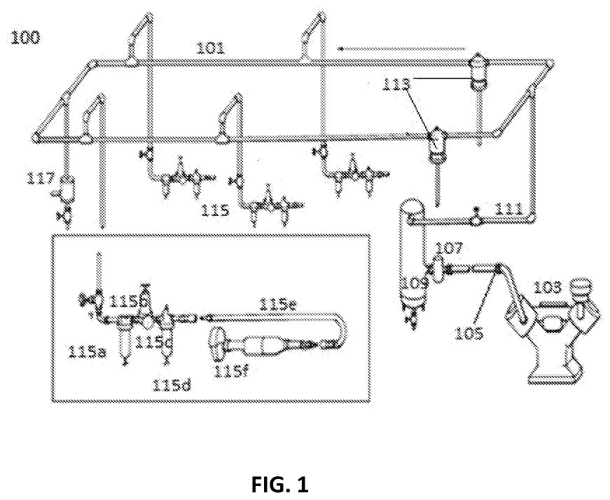

The waterless system is a portable assembly which includes one or more components. The components of the waterless system may be assembled/dissembled upon use. As shown in FIG. 1, the waterless system 100 includes a frame 101. The frame 101 may be installed at the top edges of a solar panel. In an embodiment, the frame 101 is inclined at an angle with respect to a horizontal base, say ground at the top of the solar panel. The angle may correspond to the angle of inclination of the solar panel with respect to the horizontal base. The dimensions of the frame 101 may be dependent upon the size of solar panel for which it is employed. The height of the frame 101 may be such that it creates minimum shadow on the corresponding solar panel.

The frame 101 of the waterless system 100 may include a plurality of pipes 101a and a plurality of attachments. The pipes 101a may be constructed of any strong, durable and inert material. The pipes 101a may include without limitation, flexible hoses, chlorinated polyvinyl chloride pipes, aluminum pipes, etc. The pipes 101a may in turn be connected via connectors 101b. Each connector 101b and pipe 101a may mate with each other via a plurality of threads. However, any other means to connect two pipes 101a may also be employed. The pipes 101a may include a provision to prevent leakage. For example, the pipes 101a may be coated or covered with armour.

The attachments of the waterless system 100 may include without limitation, one or more of a compressor 103, an aftercooler 105, a moisture collector 107, an air tank 109, a shut-off valve 111, at least one drain 113, at least one work station 115, and at least one drain trap 117.

The compressor 103 may be any kind of air compressor known in the art such as a reciprocating compressor, a rotary screw compressor, a rotary vane compressor, a rolling piston, a scroll compressor, a diaphragm compressor, an air bubble compressor or may even be a direct drive compressor. The compressor 103 may be connected to an air source at one end. The compressor 103 compresses the air from the air source to a predefined pressure to yield compressed air (or pressurized air). The pressure applied in the compressor 103 may range between 30 to 240 psi.

The compressor 103 may release the compressed air based upon environmental conditions. In an embodiment, the waterless system 100 includes one or more sensors which sense the environmental conditions.

The compressor 103 may be sequentially followed by the aftercooler 105 and the moisture collector 107. The aftercooler 105 may be any type of heat exchanger known in the art which functions to cool the discharge from the compressor 103. The aftercooler 105 reduces the amount of water vapour present in the compressed air by condensing the water vapour into liquid form.

The moisture collector 107 removes moisture from the waterless system 100 which is generated by the aftercooler 105. The moisture collector 107 may be any type of moisture collector known in the art and may utilize without limitation, silica gel, calcium chloride, etc. to absorb moisture.

The air tank 109 is placed next to the moisture collector 107. The air tank 109 is also coupled to the compressor 109. The air tank 109 serves as a reservoir to store the compressed air obtained from the compressor 103. The size of the air tank 109 may be large enough to accommodate the compressed air discharged from the compressor 103. Also large surface area of the air tank 109 helps in dissipating heat from the compressed air.

The air tank 109 is a concealed chamber with an input line 109a and an output line 109b. As shown in FIG. 1, the input line 109a is connected to the compressor 103 while the output line 109b provides a channel to discharge the compressed air further to the subsequent components of the waterless system 100. The air tank 109 may include a discharge valve 109c placed at its bottom. The discharge valve 109c functions to empty the air tank 109 in case of any leakage repair, etc. Moreover, it may also be utilized to drain out the presence of any trace of water. Optionally/additionally, the air tank 109 may include a pressure indicator which displays the pressure of the compressed air.

The storage of compressed air in air tank 109 helps to control the pulsating flow of the compressed air from the compressor 103. It also helps the compressed air to further cool and condense the moisture present thereof. The pressure in the air tank 109 is held higher than the system operating pressure to compensate pressure loss in the pipes.

A shut-off valve 111 may be disposed at a predetermined distance from the air tank 109. The shut-off valve 111 may be coupled to the air tank 109. The shut-off valve 111 functions to regulate and monitor the direction flow of compressed air. The shut-off valve 111 is a programmable device (in conjunction with a microprocessor). The shut-off valve 111 may be in open or close state depending upon the requirement. In an embodiment, a solenoid valve is used for the same purpose.

The waterless system 100 may include a drain 113. The drain 113 may be a manual or an automatic drain. Preferably, in order to automate the waterless system 100, automatic drains, for example, float operated drains, electronic sensor drains and electronic timer drains may be employed. The drain 113 acts as a receiver to hold the condensate of the compressed air.

The work station 115 is the main component of the waterless system 100 which performs cleaning of the solar panel. Each solar panel may have a single work station 115 or optionally multiple work stations 115 may be employed for cleaning the solar panel. The number of work stations 115 may depend upon the size of the solar panel system. The work stations 115 may be disposed on the frame 101 along the length on either side as shown in FIG. 1. The work stations 115 may be placed at a height lower than the frame 101. For this arrangement, the work stations 115 may be supported on the frame 101 with the help of additional pipes which help in mounting the work stations 115 at a lower level. The work station 115 may include, without limitation, one or more of a shut-off valve 115a, an air filter 111b, a pressure regulator 111c, a lubricator reservoir 111d and a nozzle assembly 111e.

The shut-off valve 115a may be structurally similar to the shut-off valve 111 and is employed for the similar purpose. The air filter 115b is placed next to the shut-off valve 115a. The air filter 115b is a device which may be composed of one or more fibrous materials. The fibrous materials in turn remove contaminants like solid particulates such as dust, pollen, mould, and bacteria from the air. The air filter 115b may additionally/optionally include a catalyst or an absorbent to enhance the filtering efficiency of the air filter 115b. Therefore, the air filter 115b filters the compressed air to result in contaminant free compressed air which is subsequently dispensed.

The lubricator reservoir 115d may be placed next to the pressure regulator 115c. The lubricator reservoir 115d stores a lubricator for lubricating the components of the waterless system 100. Any lubricator which provides the following advantages: excellent rust and corrosion protection, high oxidation stability to maintain its viscosity and provide long service life, non-foaming, demulsibility properties to shed water and filterability without the worry of lubricant additive depletion, may be used in the waterless system 100.

The nozzle assembly 115e may be detachably connected to the work station 115. The nozzle assembly 115e may have predefined dimensions. The nozzle assembly 115e may be flexible assembly which may be angled at a particular inclination for providing more ease in cleaning of the solar panel.

The nozzle assembly 115e may include a tube 115f and a nozzle 115g. The nozzle 115g may be a pipe or tube of varying cross sectional area. The nozzle 115g may be used to direct or modify the flow of air. The nozzle 115g may also control the rate of flow, speed, direction, mass, shape, and/or the pressure of the compressed air that emerges from them. The nozzle 115g increases the velocity of compressed air at the expense of its pressure energy. The nozzle 115g of the waterless system 100 is a wide angled nozzle and delivers a compressed air jet to clean the solar panel.

The drain trap 117 may be placed along the width of the frame 101. The drain trap 117 functions in removing liquid continuously and automatically without wasting air or gas.

In an embodiment, the components of waterless system 100 as disclosed above may vary based upon different environmental conditions and customized for different sizes of solar plants. For example, the waterless system 100 may include increased number of nozzle assemblies 115e for geographical locations prone to dusty weather such as desserts and/or when the size of solar plant is more.

The waterless system 100 as elaborated above may be mounted over a solar panel system. In order to enhance the cleaning efficiency of the waterless system 100 furthermore, the corresponding solar panel(s) may be coated with a coating/solution. The coating may be performed over a top surface of a solar panel. The solution may be a nano solution which may be for example, based on silicon by Si—O—Si bond. In an embodiment, the coating is a glass nano coating. The solution may be such that the glass surface of solar panel is rendered non sticky and slippery. The solution may have a flash point near 16° C. and self-igniting at approximately 200° C.

Nano coatings may be applied safely since they are chemically inert, tasteless, and colorless and have mild aroma. Further, nano coatings are stable in various environmental conditions and resist as well as protect surfaces against dirt, scratches and impacts. Nano coatings impart a glossy finish having a wet appearance with excellent durability to the surface. Several coating layers may be applied over the glass surface to result in better coverage.

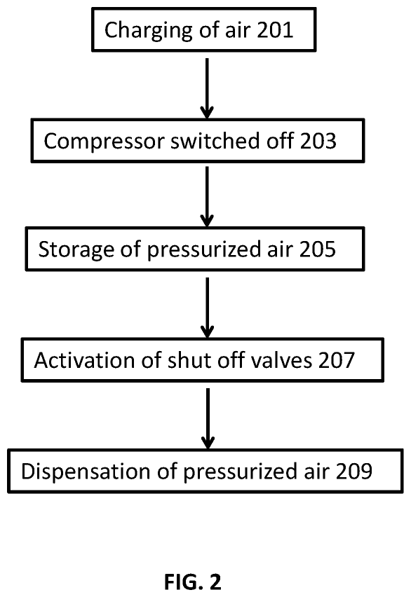

FIG. 2 represents the working of the waterless system 100. The waterless system 100 is an automated system with the microprocessor which controls synchronized operation of all the components of waterless system 100. It must be noted that FIG. 2 represents an exemplary working which substantiates the activation of a single work station. However, the waterless system 100 is additionally equipped to selectively activate few or all work stations out of multiple work stations at a time.

The waterless system 100 is switched on and subsequently, the compressor 103 starts to charge the air at step 201. At step 203, once the air is charged and reaches a predefined pressure, the compressor 103 stops automatically.

The microprocessor may determine the predefined pressure based upon the environmental conditions as sensed by the one or more sensors. The waterless system 100 may additionally include a pressure sensor which senses the pressure of compressed air at regular intervals, for example in every 2 minutes and transmits the same to the microprocessor. As soon as the pressure of the compressed air reaches the predefined pressure, the microprocessor signals the compressor 103 to stop.

The compressed air having predefined pressure is then stored in the air tank 109 after passing through the aftercooler 105 and moisture collector 107 at step 205. It is important to note that the pressure of the compressed air is maintained at the predefined pressure while its storage.

At step 207, the microprocessor activates the shut-off valves 111 and 115a to start the cleaning operation. The compressed air from the air tank 109 then flows through the frame 101 and subsequently flows through the work station 115.

A timer is actuated to auto start the cleaning operation for an optimum time. The timer may be set for a predetermined period of time and at regular intervals throughout the day (or a timer value). The timer value may be selected by the microprocessor. The microprocessor may refer to the look up tables for selecting the timer value dependent upon the environmental conditions.

At step 209, the compressed air is dispensed via the wide angle nozzle 115g to the corresponding solar panel.

The foregoing description of preferred embodiments of the present disclosure provides illustration and description, but is not intended to be exhaustive or to limit the disclosure to the precise form disclosed. Modifications and variations are possible in light of the above teachings or may be acquired from practice of the disclosure.

No element, act, or instruction used in the description of the present disclosure should be construed as critical or essential to the invention unless explicitly described as such. Also, as used herein, the article “a” is intended to include one or more items. Where only one item is intended, the term “one” or similar language is used.

We claim:

1. A waterless system for cleaning solar panels, the waterless system comprising:
one or more solar panels having a top surface, the top surface provided with a nano coating;
at least one compressor, the compressor configured to pressurize air at a predefined pressure,
an air tank coupled to the at least one compressor for storing pressurized air;
at least one shut-off valve coupled to the air tank for regulating the flow of the pressurized air;
a microprocessor in communication with the compressor and the shut-off valve for directing the opening and closing of the compressor and the shut-off valve;
a frame mounted on top of the one or solar panels for facilitating air flow and coupled to the shut-off valve; and
at least one work station coupled to the frame including a nozzle assembly for release of the pressurized air directed to the nano coated one or more solar panels for cleaning purposes.

2. The waterless system as claimed in claim 1 wherein the nano coating includes a glass nano coating.

3. The waterless system as claimed in claim 1 wherein the predefined pressure ranges from 30 to 240 psi.

4. The waterless system as claimed in claim 1 wherein the system includes an aftercooler coupled to the compressor.

5. The waterless system as claimed in claim 1 wherein the system includes a moisture collector coupled to the aftercooler.
